(19) United States
(12) Patent Application Publication
(10) Pub. No.: US 2024/0249349 A1
(43) Pub. Date: Jul. 25, 2024

(54) CLIENT LEVEL ANALYSIS CRITERIA

(71) Applicant: Truist Bank, Charlotte, NC (US)

(72) Inventors: Randy Eric Borth, Concord, NC (US); Candice Mercer Roberts, Harrisburg, NC (US); WeiJen Lu, Raleigh, NC (US)

(73) Assignee: Truist Bank, Charlotte, NC (US)

(21) Appl. No.: 18/157,276

(22) Filed: Jan. 20, 2023

(51) Int. Cl. G06Q 40/02

(52) U.S. Cl. CPC G06Q 40/02

(57) ABSTRACT

A framework for client level analysis criteria, communication and actions in a digital banking system. Clients with a tiered account at a bank using the digital banking system achieve promotion to a higher tier or level based on total deposits in the account or other criteria. Various communication methodologies are used to notify the client of the promotion to the higher tier, including push notifications and displays in the digital banking system itself. The notifications and displays include insights into new features and benefits which have been unlocked in the higher tier and are now available to the client. Gamification techniques are used to increase client engagement in the system, such as teasers to entice the client to try the new features and learn more about the new benefits, and insights which improve client understanding of their financial situation and how to use available features and benefits to improve it.

### FIELD

The present disclosure relates generally to the field of digital banking systems, and more particularly to a graphical user interface and communication methodology in a digital banking system which provides notifications to clients when a higher tier is achieved for an account, where the notifications include insights into new features and benefits available in the higher tier, and teasers designed to entice the client to try the new features and learn more about the new benefits.

### BACKGROUND

Digital banking systems are well known and used by many bank businesses and their customers. Two common types of digital banking systems are online web-based systems which interact with a user via a web browser window on a computer, and mobile applications (“apps”) which run on mobile devices such as smart phones and tablets. Both online web-based banking systems and mobile banking apps communicate with back-end servers which validate and execute specific transactions, provide data for display, etc. Both web-based and mobile app-based systems also include security and customer authentication features, where user-provided information and/or biometric information is collected from the customer and validated with data stored on the back-end server. Digital banking systems, including web-based and mobile app-based systems, are often referred to as online banking systems, which terms will be used interchangeably throughout the present disclosure.

Each customer has one or more accounts with the bank, which the customer may access and manage using the digital banking system. The accounts might include checking and/or savings accounts, credit cards, and possibly investment accounts or others. Customers typically receive periodic statements for each account—such as a monthly credit card statement—in which every transaction is listed (deposits, withdrawals, purchases, payments, etc.) and a new account balance is shown. These statements may be in paper or electronic form.

Customers who use a bank's digital banking systems also have access to near-real-time account information, where transactions are posted to the account ledger soon after the transaction's occurrence. For example, a credit card purchase at a coffee shop will often appear in the online transaction list for the credit card account within minutes of the purchase. This allows savvy online banking customers to regularly review their transaction list (e.g., to spot potential fraud) and also to keep track of their current account balance. These online transaction lists directly access data from a transaction database, and may be updated many times each day. By contrast, the account statements (described above) are produced only at the close of a statement period—such as monthly.

Digital banking systems are also known to provide other data for customer accounts besides the aforementioned transaction lists. For example, digital banking systems may provide a summary of spending or account balance for recent months, and the systems also typically offer convenience to the customer by way of links to features which customers often use—such as check deposits, money transfers and bill paying.

In spite of the capabilities of digital banking systems discussed above, some customers do not take full advantage of features available in the systems, and may make mistakes (such as overdrawing a checking account) which are entirely preventable and could have been avoided if the customer had simply used the online banking tools available at their disposal. In addition, some customers continue to rely on in-person visits to branch offices to conduct banking activity which could be done online, these branch office visits result in unnecessary time and travel for the customer, and creates an increased need for bank personnel to staff the branch offices, all of which is sub-optimal.

Although existing digital banking systems provide many useful features and functions for bank customers, there is a need for an online banking system which increases customer engagement and encourages greater customer usage of the digital banking system's features, in order to improve the overall customer experience and also streamline the bank's operations.

### BRIEF SUMMARY

The present disclosure describes a framework for client level analysis criteria, communication and actions in a digital banking system. Clients with a tiered account at a bank using the digital banking system achieve promotion to a higher tier or level based on total deposits in the account or other criteria. Various communication methodologies are used to notify the client of the promotion to the higher tier, including push notifications to users of a mobile banking application and displays in the user interface of the digital banking system itself. The notifications and displays include insights into new features and benefits which have been unlocked in the higher tier and are now available to the client. Gamification techniques are used in the notifications and displays in order to increase client engagement in the system, such as teasers designed to entice the client to try the new features and learn more about the new benefits, and insights which improve client understanding of their financial situation and how to use available features and benefits to improve it.

The features, functions, and advantages that have been discussed may be achieved independently in various embodiments of the present disclosure or may be combined in yet other embodiments, further details of which can be seen with reference to the following description and drawings, along with the appended claims.

### BRIEF DESCRIPTION OF THE DRAWINGS

FIG. 1 illustrates an enterprise system, and environment thereof, including a centralized server system, distributed computers and mobile devices, and communication therebetween, according to at least one embodiment of the present disclosure;

FIG. 2 is a simplified illustration of the enterprise system of FIG. 1, showing the elements most directly involved in the communication of a level upgrade to a tiered client account embodied in the present disclosure;

FIG. 3 is a mock-up illustration of a display screen of the mobile device showing a teaser notification advising a client of an account tier or level upgrade which has been achieved, and encouraging client engagement with the digital banking system to learn more, according to an embodiment of the present disclosure;

FIGS. 4A/4B/4C are mock-up illustrations of the display screen of the mobile device of FIG. 3, each illustration depicting an insight story presented in the digital banking system application which explains to the client new features and benefits available as a result of achieving an account tier or level upgrade, according to an embodiment of the present disclosure; and

FIG. 5 is a flowchart diagram of a method for determining and communicating a level upgrade to a tiered client account, according to an embodiment of the present disclosure.

### DETAILED DESCRIPTION OF EMBODIMENTS

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

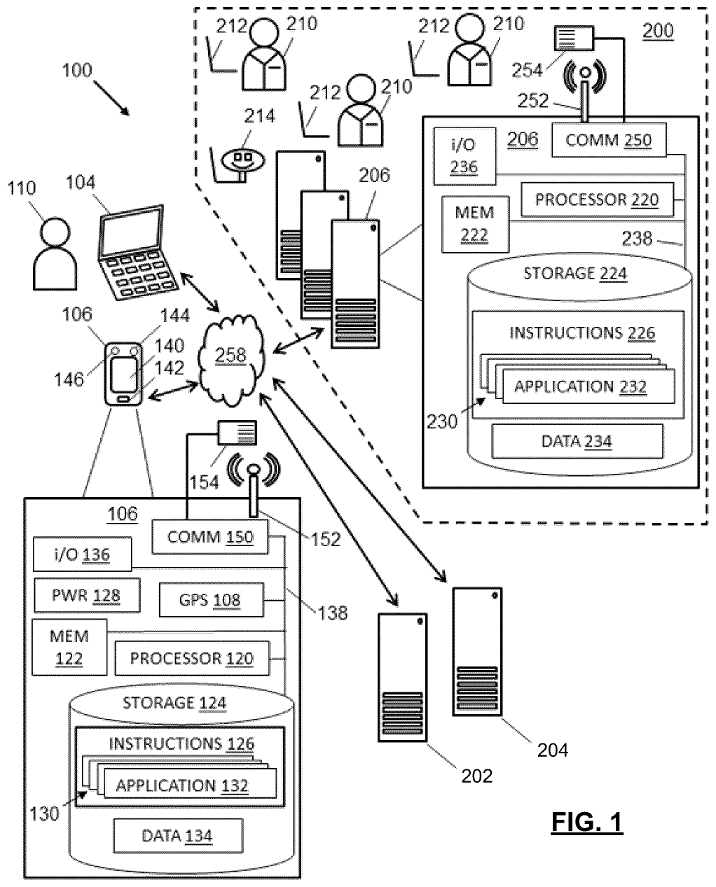

FIG. 1 illustrates a system 100 and environment thereof, including centralized and distributed computing devices, according to at least one embodiment, by which a user 110 benefits through use of services and products of an enterprise system 200. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, user input devices and user output devices, which are operatively coupled to the processing device 120. The user output devices include a display 140 (e.g., a liquid crystal display or the like), which can be, as a non-limiting example, a touch screen of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, and/or other input device(s). The user interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The mobile device 106 may also include a positioning device 108, which can be for example a global positioning system device (GPS) configured to be used by a positioning system to determine a location of the mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device. As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the mobile device 104 and computing device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11 a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

Two external systems 202 and 204 are illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third party systems such as merchant systems configured to interact with the user device 106 during transactions and also configured to interact with the enterprise system 200 in back-end transactions clearing processes.

In certain embodiments, one or more of the systems such as the user device 106, the enterprise system 200, and/or the external systems 202 and 204 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

As used herein, an artificial intelligence system, artificial intelligence algorithm, artificial intelligence module, program, and the like, generally refer to computer implemented programs that are suitable to simulate intelligent behavior (i.e., intelligent human behavior) and/or computer systems and associated programs suitable to perform tasks that typically require a human to perform, such as tasks requiring visual perception, speech recognition, decision-making, translation, and the like. An artificial intelligence system may include, for example, at least one of a series of associated if-then logic statements, a statistical model suitable to map raw sensory data into symbolic categories and the like, or a machine learning program. A machine learning program, machine learning algorithm, or machine learning module, as used herein, is generally a type of artificial intelligence including one or more algorithms that can learn and/or adjust parameters based on input data provided to the algorithm. In some instances, machine learning programs, algorithms, and modules are used at least in part in implementing artificial intelligence (AI) functions, systems, and methods.

Artificial Intelligence and/or machine learning programs may be associated with or conducted by one or more processors, memory devices, and/or storage devices of a computing system or device. It should be appreciated that the Al algorithm or program may be incorporated within the existing system architecture or be configured as a standalone modular component, controller, or the like communicatively coupled to the system. An Al program and/or machine learning program may generally be configured to perform methods and functions as described or implied herein, for example by one or more corresponding flow charts expressly provided or implied as would be understood by one of ordinary skill in the art to which the subjects matters of these descriptions pertain.

A machine learning program may be configured to implement stored processing, such as decision tree learning, association rule learning, artificial neural networks, recurrent artificial neural networks, long short term memory networks, inductive logic programming, support vector machines, clustering, Bayesian networks, reinforcement learning, representation learning, similarity and metric learning, sparse dictionary learning, genetic algorithms, k-nearest neighbor (KNN), and the like. In some embodiments, the machine learning algorithm may include one or more image recognition algorithms suitable to determine one or more categories to which an input, such as data communicated from a visual sensor or a file in JPEG, PNG or other format, representing an image or portion thereof, belongs. Additionally or alternatively, the machine learning algorithm may include one or more regression algorithms configured to output a numerical value given an input. Further, the machine learning may include one or more pattern recognition algorithms, e.g., a module, subroutine or the like capable of translating text or string characters and/or a speech recognition module or subroutine. In various embodiments, the machine learning module may include a machine learning acceleration logic, e.g., a fixed function matrix multiplication logic, in order to implement the stored processes and/or optimize the machine learning logic training and interface.

One type of algorithm suitable for use in machine learning modules as described herein is an artificial neural network or neural network, taking inspiration from biological neural networks. An artificial neural network can, in a sense, learn to perform tasks by processing examples, without being programmed with any task-specific rules. A neural network generally includes connected units, neurons, or nodes (e.g., connected by synapses) and may allow for the machine learning program to improve performance. A neural network may define a network of functions, which have a graphical relationship. As an example, a feedforward network may be utilized, e.g., an acyclic graph with nodes arranged in layers.

Having described an enterprise computing environment as might be used by a banking business, and general characteristics of systems which may be employed in the enterprise computing environment, attention is now turned to the specific topic of the present disclosure—a framework for client level analysis criteria, communication and actions in a digital banking system.

Digital banking systems are well known and used by many bank businesses and their customers, including online web-based systems which interact with a user via a web browser window, and mobile applications (“apps”) which run on mobile devices such as tablets and smart phones. Both online web-based banking systems and mobile banking apps communicate with back-end servers which validate and execute specific transactions, provide data for display, etc.

Banking customers have at least one account, and often more than one account, with a bank business. These accounts may include savings accounts, checking accounts, investment accounts, credit cards, loans, mortgages, etc. Customers receive a statement for each account, typically once per month. The statement lists a beginning balance, all transactions for the statement period, and an ending balance, among other things. Online banking systems (also known as digital banking systems) also typically provide customers with access to near-real-time transaction lists for each account, where transactions appear in the online system as soon as they are posted to the bank's back end database.

Despite the availability of online banking systems having many convenient features, some customers continue to do their banking the old fashioned way—driving to a bank branch office to deposit checks, using check registers and paper statements to keep track of account balances, and so forth. These outmoded practices create waste in several ways—including increased travel and time for the customer, missed opportunities for customer benefits, increased risk of overdraft mistakes by the customer, increased consumption of paper for printed statements, and an increased need for personnel to staff bank branch offices.

The techniques of the present disclosure describe methods for encouraging customers (clients) to earn higher account status levels or tiers, communicating the features and benefits associated with each tier to the client to increase engagement with the digital banking system, and using teasers to provide client insights into financially beneficial opportunities. The corresponding notification and display techniques are discussed below with respect to the remaining figures.

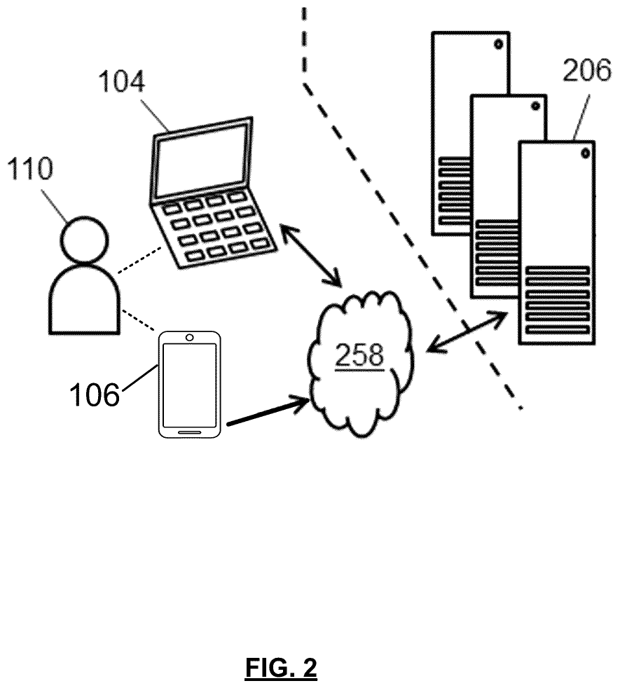

FIG. 2 is a simplified illustration of the enterprise architecture depicted in FIG. 1, showing the elements most directly involved in the communication of a level upgrade to a tiered client account embodied in the present disclosure. The user 110 uses either the computing device 104 or the mobile device 106 to access a digital banking system, where the computing device 104 would run a web browser application in which the digital banking system is displayed, and the mobile device 106 would run a mobile app specifically designed as the digital banking system. The computing device 104 and/or the mobile device 106 communicate with the computing system (back-end servers) 206 via the network (“cloud”) 258. These devices and their interactions in the client account level upgrade procedure are discussed below.

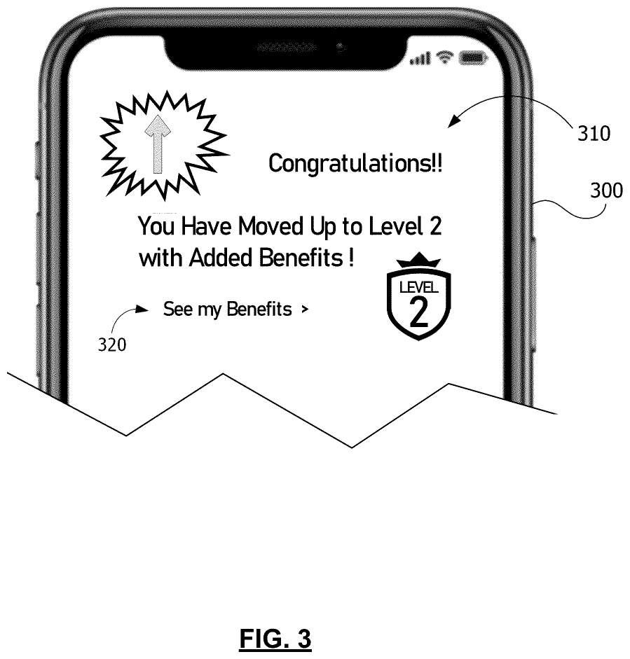

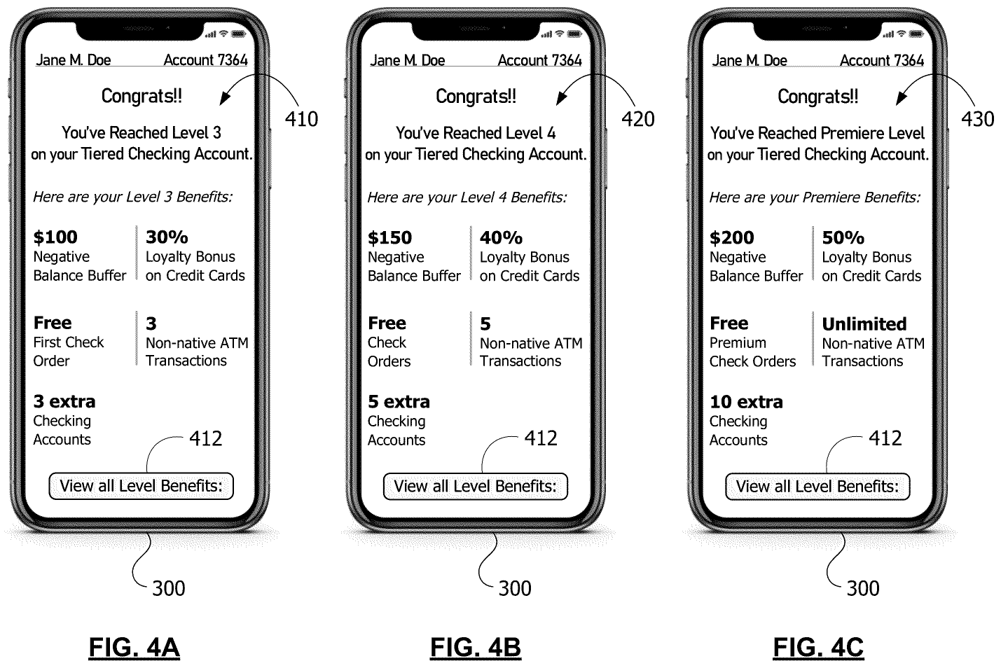

FIG. 3 is a mock-up illustration of a display screen of the mobile device 300 showing a teaser notification advising a client of an account tier or level upgrade which has been achieved, and encouraging client engagement with the digital banking system to learn more, according to an embodiment of the present disclosure. The mobile device 300 of FIGS. 3 and 4 corresponds with the mobile device 106 in the architecture diagrams of FIGS. 1 and 2. It is to be understood that the mobile device 300 runs a digital banking system mobile application (“app”), and that the mobile device 300 communicates with a back-end server (corresponding with the computing system 206) to access client account data.

The basic premise of the presently disclosed technique is that, for some types of client accounts, such as certain types of checking accounts, different levels or tiers are assigned to each client's account based on a total balance in the account or other selected criteria. Each tier has different rewards and benefits associated with it, with the lowest or most basic benefits for entry level (e.g., Tier 1) accounts, and the greatest benefits for the highest level (e.g., Tier 5 or “Premiere”) accounts. Furthermore, a “gamification” approach is used in connection with the account level progression, where the achievement of a higher level is communicated to the client in a way which encourages client engagement with the digital banking system and also causes the client to aspire to even higher levels and their associated benefits.

In FIG. 3, a teaser notification 310 is provided to the client as a display element on the mobile device 300. The teaser notification 310 advises the client that his or her account has been upgraded to a higher tier or level, and provides a link (identified at 320) for the client to click/tap to learn more about the benefits of the newly achieved tier. The notification 310 may be a push notification which appears on the display screen of the mobile device 300 momentarily after being sent by the back-end server. As understood by those skilled in the art, push notifications for a particular mobile app (in this case, the digital banking system app) are sent to devices (one, some or all) which have the app installed, thereby providing near-real-time notification of an event or other communication. In this case, the notification 310 is sent to just a single user/client, on the mobile device 300, based on the client having an account which was just upgraded to a higher level. When the notification 310 is a push notification, the link 320 preferably launches or invokes the digital banking system mobile app and displays the tier benefit information in the app. In the example shown in FIG. 3, where the client's account was just upgraded to Level 2, the link 320 would cause the app to display a page showing the Level 2 benefits.

The notification 310 may also be provided as a text message to the mobile device 300 at a client mobile phone number of record, or as an email to a client email address of record. In these cases, the link 320 would either launch the digital banking system mobile app, or navigate to the digital banking system site in a web browser app.

In addition to the push notification, text message and/or email communication discussed above, the notification 310 may be embodied as a pop-up message in the digital banking system mobile app or web browser app. That is, when the client/user is using the digital banking system mobile app or web browser app, the notification 310 would appear as a pop-up message in the digital banking system display window. This is as opposed to the other embodiments (push notification, text message and/or email) which are delivered to the user outside the display environment of the digital banking system.

The advancement of a client account to a higher level or tier is determined by an algorithm running on the back-end server. The advancement algorithm may include evaluation of various criteria, as determined to be most suitable by the bank. For example, advancement may be triggered by an account balance (instantaneous or average over a defined period) exceeding a threshold value, total deposits exceeding a threshold value, aggregate cash flow exceeding a threshold value (indicating a lot of account activity), and/or combinations of these or other criteria. In some embodiments, the advancement criteria may include consideration of other accounts held by the client at the bank (“linked accounts”), not just the account to which the level upgrade applies. When the algorithm triggers advancement, the notification 310 is sent to the client as discussed above.

FIGS. 4A/4B/4C are mock-up illustrations of the display screen of the mobile device 300 of FIG. 3, each illustration depicting an insight story presented in the digital banking system application which explains to the client new features and benefits available as a result of achieving an account tier or level upgrade, according to an embodiment of the present disclosure. The mobile device 300 is the same device in all of FIGS. 4A-C, with each figure depicting a different level upgrade scenario.

In FIG. 4A, an insight story 410 is displayed on the screen of the mobile device 300. The insight story 410 indicates the benefits which have been “unlocked” as a result of the client account being upgraded to Level 3. In the example shown in FIG. 4A, the benefits associated with Level 3 include a $100 negative balance buffer (without incurring overdraft fee), a 30% loyalty bonus on credit cards which the client holds with the bank (boosting rewards points by 30%), a free first order of checks, three non-native ATM transactions (transactions at ATMs belonging to other banks), and three extra checking accounts without regular monthly fees.

Each of the benefits listed in the insight story 410 may be clicked on (or hovered over) by the user/client in order to get more information. For example, the user could click on the credit card bonus element to learn more about how the 30% bonus applies. In some cases, the additional details are provided in a temporary pop-up bubble, and in other cases clicking to get additional details takes the user to a different web page or app page, preferably with a link to conveniently return to the previous page. The ability for the client to “drill down” into the details of the benefits is another way of encouraging client engagement with the digital banking system app, which in turn increases the client's familiarity and comfort with the system.

In FIG. 4B, an insight story 420 is displayed on the screen of the mobile device 300. The insight story 420 indicates the benefits which have been unlocked as a result of the client account being upgraded to Level 4. In the example shown in FIG. 4B, the benefits associated with Level 4 include a $150 negative balance buffer, a 40% loyalty bonus on credit cards, free check orders, five non-native ATM transactions, and five extra checking accounts. Each of the Level 4 benefits in the insight story 420 is incrementally improved over the corresponding Level 3 benefit. Likewise, FIG. 4C displays an insight story 430 where each of the benefits associated with the account being upgraded to “Premiere Level” are further improved over the Level 4 benefits.

In each of the insight stories 410/420/430, a button 412 is provided which the user can click in order to view all level benefits. In a preferred embodiment, the button 412 (regardless of on which level of insight story it is clicked) takes the user to a page which lists the benefits for each of the levels (e.g., Level 1—Premiere Level). The page which lists the benefits could be a page in the digital banking system mobile app, or it could be a web page on the bank's website for example.

All of the benefits listed in FIGS. 4A-C are of course exemplary. Different numeric values may be used for each benefit without departing from the spirit of the present disclosure, and not every benefit must necessarily change value at every level upgrade. Additionally, new benefits may be unlocked as the account level progresses. For example, Level 4 could have a new benefit (such as an interest rate boost on account balances) which was not included at all in Levels 1-3, and Premiere Level could include all of the benefits of Level 4 at improved values plus still other benefits.

Furthermore, the insight stories 410/420/430 and the associated benefits may be customized to each individual client, for each account level. For example, an individual who has been a client of the bank for many years may receive more benefits and/or incrementally improved benefits at each level as compared to the standard level benefits. The same type of logic could be applied to clients holding several other accounts at the bank. Another example would be where the spending patterns of a particular client account (e.g., categories of purchases having high spending, or frequent purchases from a certain merchant) are used to customize the rewards at each account level. Many different types of logic may be applied to customize the benefits and insights to each client at each level. This logic can be programmed into the advancement algorithm discussed earlier; this algorithm runs on the back-end server, which has access to a wealth of client account data (including detailed data about every transaction) upon which to base the logic, trigger the advancement and customize the benefits and insights.

The insight stories depicted in FIGS. 4A-C are displayed in the digital banking system mobile app. For example, referring back to FIG. 3, when the user clicks on the link 320 (to “See my Benefits”), this would launch the digital banking system mobile app and display the insight story for the appropriate tier or level. The insight stories of FIGS. 4A-C, describing benefits for the client's tier or level, may also be accessed upon demand within the digital banking system mobile app or web browser app. For example, when running the digital banking system mobile app or web browser app, the client's current level is preferably displayed somewhere on the screen, and either the level number itself or a nearby link may be clicked in order to display the insight story (e.g., 410, 420, 430) for the appropriate tier or level.

As discussed above, one of the purposes of the notifications and insights is to encourage client engagement in the digital banking system mobile app or web browser app. This is done because client familiarity with the digital banking system app increases through repeated use of the system, and increased familiarity leads to increased client satisfaction and an increase in the likelihood of the client's use of new features.

However, because many of the benefits of the client's account level are not directly tied to online banking, a client account level advancement may also trigger the sending of one or more physical documents in the mail—including a letter explaining the level advancement and the new benefits, and a card (e.g., a wallet-sized card) indicating the account level and listing the benefits. The document mailing would be programmed into the advancement algorithm on the back-end server (discussed above) and would be triggered along with the notification 310 of FIG. 3 when the advancement criteria are met.

The positioning and size/shape of the various display elements within the insight stories 410/420/430 may of course be changed without departing from the spirit of the present disclosure. For example, the benefits could be arranged in different locations or displayed in a list format rather than a grid format, the button 412 could be positioned differently, etc.

FIGS. 3 and 4 illustrate digital banking system interactions on a mobile device such as a smart phone. It is to be understood that in other embodiments of the present disclosure, equivalent notifications and displays may be provided on a display screen of user computing device such as a personal computer, where the personal computer typically runs a web browser application and the digital banking system is accessed using the web browser. The size and positioning of the various notifications and displays may be different on a computer display screen than on a mobile device, but all of the notification and display features discussed above are available on either type of user computing device accessing the digital banking system.

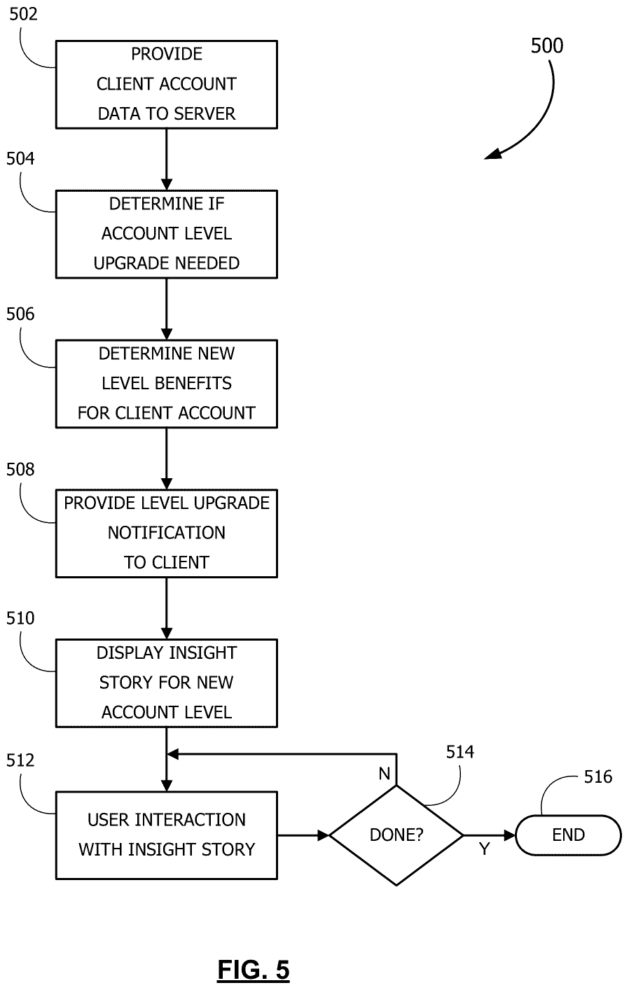

FIG. 5 is a flowchart diagram 500 of a method for determining and communicating a level upgrade to a tiered client account, according to an embodiment of the present disclosure. At box 502, client account data is provided to a server computer. The client account data includes data for many different clients, each client having one or more accounts. Many of the clients will have a tiered account of the type discussed in the present disclosure. At box 504, it is determined whether an account level upgrade is merited. This determination is made for each of the tiered accounts on a periodic basis (e.g., hourly or daily), or upon detection of a triggering event such as a deposit. The level upgrade determination is based on the client account data and a set of predefined upgrade criteria. The upgrade criteria may be based on a single factor such as account balance, or may be based on multiple factors. In a typical embodiment, the level upgrade determination is performed in the advancement algorithm running on the server computer as discussed earlier.

At box 506, when an account level upgrade to a new level is merited, account benefits at the new level are determined. The account benefits for the new level may be a standard set of benefits for the particular level achieved (e.g., the Level 3 benefits shown in the insight story 410), or the account benefits for the new level may be customized to the particular client and account. The customization would take factors into consideration such as client history, linked accounts for the client, and analysis of account activity such as transactions (categories, merchants, etc.). The account benefit determination is performed by the server computer, such as in the same advancement algorithm discussed above.

At box 508, notification of the upgrade to the new level is provided to the client as illustrated in FIG. 3. The notification at the box 508 is a teaser designed to inform the client of the upgrade and encourage client engagement with the digital banking system application to learn more. The notification at the box 508 is initiated by the server computer, and may be in the form of a push notification, a text message or an email, for example. At box 510, an insight story describing the account level upgrade is displayed on a user device running the digital banking system, as illustrated in FIG. 4. The benefit information included in the insight story is provided by the server computer based on the benefit determination at the box 506, where the benefit information is transmitted over a network from the server computer to the user device. The insight story is displayed on the user device when the particular client accesses (logs into) the digital banking system application—either in mobile app form or web-based form. The insight story may be automatically displayed by the system (such as the first time the client accesses the application after the level upgrade occurs), or the insight story may be displayed upon demand by the client (such as by clicking on the level number in the application).

At box 512, the user interacts with the insight story as desired—such as by hovering over or clicking on a display element of the insight story to learn more about a particular level benefit, or all level benefits. The user interaction at the box 512 includes receiving user input via the user device, transmitting an information request from the user device to the server computer over the network, and transmitting additional information from the server computer to the user device over the network. The user interaction may repeat or continue as indicated by the client at a decision diamond 514, ultimately leading to a terminus 516.

It is to be understood that the method of FIG. 5, and the user interface and graphical display features shown on FIGS. 3-4, are programmed as one or more algorithm which runs on the computing system 206 (the enterprise server) cooperatively and interoperably with the computing device 104 and/or the mobile device 106 of the customer. For example, the back-end server (computing system 206) determines when an account meets level upgrade criteria and then sends the teaser notification and defines the insight story; the computing device 104 or the mobile device 106 displays the notification and/or the insight story in the digital banking system application, and receives input from the user in the form of mouse clicks and screen taps along with optional keyboard inputs, and provides the user inputs to the computing system 206 which delivers data (e.g., benefit details, etc.) back to the computing device 104 or the mobile device 106. These devices all include processors, memory and communication modules suitable to run the algorithm(s) and perform the digital banking client account level analysis and communication in the manner described throughout the present disclosure.

The client account level upgrade criteria, communication and actions, discussed above, provide advantageous features in connection with tiered accounts—particularly including insights into new features and benefits which have been unlocked in a higher account level and are now available to the client. The notifications and displays include gamification techniques which are used in order to increase client engagement in the system, such as teasers designed to entice the client to try the new features and learn more about the new benefits, and insights which improve client understanding of their financial situation and how to use available features to improve it. These techniques collectively lead to increased customer satisfaction and ultimately a growing customer base for the bank.

Particular embodiments and features of the disclosed methods and systems have been described with reference to the drawings. It is to be understood that these descriptions are not limited to any single embodiment or any particular set of features. Similar embodiments and features may arise or modifications and additions may be made without departing from the scope of these descriptions and the spirit of the appended claims.

What is claimed is:

1. A method for determining and communicating a level upgrade, said method comprising:
providing, to a server computer having a processor and memory, a source of data;
analyzing the data, by the server computer, to identify a level upgrade; and
when an upgrade to a new level is identified,
determining, by the server computer, parameters for the new level;
providing a level upgrade notification to a user;
transmitting an insight story for the new level from the server computer to a user device over a network, where the insight story includes the parameters for the new level;
displaying the insight story for the new level in a graphical user interface on the user device; and
interacting with the insight story, by the user using the user device, to obtain information about the parameters for the new level.

2. The method according to claim 1 wherein the user device is a tablet device or a smart phone configured with a mobile application which communicates with the server computer.

3. The method according to claim 1 wherein the user device is a personal computing device configured with a web browser application which communicates with the server computer.

4. The method according to claim 1 wherein the data is financial data for tiered accounts of a plurality of clients of a bank, the identified level upgrade increases a level of the tiered account for a client, the parameters for the new level are benefits which the client will receive for the account at the new level, and the insight story is displayed in the graphical user interface of a digital banking system application.

5. The method according to claim 4 wherein displaying the insight story includes receiving the insight story from the server computer including data defining at least some of the benefits and displaying the insight story depicting at least some of the benefits for the account at the new level.

6. The method according to claim 5 wherein interacting with the insight story includes:
receiving user instructions requesting additional information about one of the benefits;
transmitting the user instructions from the user device to the server computer and transmitting the additional information from the server computer to the user device over the network; and
updating the display of the graphical user interface on the user device to include the additional information.

7. The method according to claim 4 wherein providing a level upgrade notification to a user includes at least one of; sending an email to the client, sending a text message to the client, and sending a push notification to the client in the digital banking system application.

8. The method according to claim 4 wherein providing a level upgrade notification to a user includes triggering, by the server computer, printing of a document and mailing of the document to the client.

9. The method according to claim 4 wherein analyzing the data to identify a level upgrade includes triggering the level upgrade when a criteria for the tiered account of the client is met, and the criteria include a total deposits value exceeding a threshold and an average or instantaneous balance exceeding a threshold.

10. The method according to claim 9 wherein analyzing the data to identify a level upgrade also includes analyzing financial data for other accounts of the client.

11. The method according to claim 4 wherein determining parameters for the new level includes setting the benefits equal to a default set of benefits for the new level and then modifying one or more of the benefits based on an analysis of the tiered account and any other accounts of the client.

12. A method for determining and communicating a level upgrade to a tiered account of a client, said method comprising:
providing, to a server computer having a processor and memory, a source of financial data for tiered accounts of a plurality of clients of a bank;
analyzing the financial data, by the server computer, to identify a level upgrade to increase a tiered account of a particular client to a new level; and
when an upgrade to a new level is identified,
determining, by the server computer, client account benefits for the new level;
providing a level upgrade notification to the particular client;
transmitting an insight story for the new level from the server computer to a user device over a network, where the insight story includes the client account benefits for the new level;
displaying the insight story for the new level in a graphical user interface of a digital banking system application on the user device; and
interacting with the insight story, by the particular client using the user device, to obtain information about the client account benefits for the new level.

13. The method according to claim 12 wherein:
analyzing the financial data to identify a level upgrade includes triggering the level upgrade when a criteria for the tiered account of the particular client is met, and the criteria include a total deposits value exceeding a threshold and an average or instantaneous balance exceeding a threshold; and
determining client account benefits for the new level includes setting the benefits equal to a default set of benefits for the new level and then modifying one or more of the benefits based on an analysis of the tiered account and any other accounts of the particular client.

14. A system for determining and communicating a level upgrade to a tiered account of a client, said system comprising:
a plurality of user devices; and
a server computer in communication with the user devices and having at least one processor and memory,
where the server computer is configured for;
reading a source of financial data for tiered accounts of a plurality of clients of a bank;
analyzing the financial data to identify a level upgrade to increase a tiered account of a particular client to a new level; and
when an upgrade to a new level is identified,
determining client account benefits for the new level;
providing a level upgrade notification to the particular client; and
transmitting an insight story for the new level to a user device of the particular client over a network, where the insight story includes the client account benefits for the new level;
and the user devices are configured for;
displaying the insight story for the new level in a graphical user interface of a digital banking system application; and
enabling interaction with the insight story, by the particular client, to obtain information about the client account benefits for the new level.

15. The system according to claim 14 wherein the user devices include tablet devices and smart phones configured with a mobile application which communicates with the server computer, and personal computing devices configured with a web browser application which communicates with the server computer.

16. The system according to claim 14 wherein enabling interaction with the insight story includes:
receiving client instructions requesting additional information about one of the benefits;
transmitting the client instructions from the user device to the server computer and transmitting the additional information from the server computer to the user device over the network; and
updating the display of the graphical user interface on the user device to include the additional information.

17. The system according to claim 14 wherein providing a level upgrade notification to the particular client includes at least one of; sending an email to the client, sending a text message to the client, and sending a push notification to the client in the digital banking system application.

18. The system according to claim 14 wherein providing a level upgrade notification to the particular client includes triggering printing of a document and mailing of the document to the particular client.

19. The system according to claim 14 wherein analyzing the financial data to identify a level upgrade includes triggering the level upgrade when a criteria for the tiered account of the particular client is met, and the criteria include a total deposits value exceeding a threshold and an average or instantaneous balance exceeding a threshold, and analyzing the financial data to identify a level upgrade also includes analyzing financial data for other accounts of the particular client.

20. The system according to claim 14 wherein determining client account benefits for the new level includes setting the benefits equal to a default set of benefits for the new level and then modifying one or more of the benefits based on an analysis of the tiered account and any other accounts of the particular client.
